(19) United States
(12) Patent Application Publication
(10) Pub. No.: US 2006/0210232 A1
(43) Pub. Date: Sep. 21, 2006

(54) Planar waveguide-based variable optical attenuator

(75) Inventors: Yuying Wu, Matsudo-shi (JP); Xiaoqing Jiang, Hangzhou (CN)

Correspondence Address: BLANK ROME LLP, 600 NEW HAMPSHIRE AVENUE, N.W., WASHINGTON, DC, 20037, US

(73) Assignee: Seikoh Giken Co., Ltd., Matsudo-shi (JP)

(21) Appl. No.: 11/371,914

(22) Filed: Mar. 10, 2006

(30) Foreign Application Priority Data
Mar. 11, 2005 (JP) P2005-070063

(51) Int. Cl. G02B 6/00

(52) U.S. Cl. 385/140

(57) ABSTRACT

A planar waveguide-based variable optical attenuator having excellent mass-productiveness and suitable for miniaturization is provided at a low cost. The planar waveguide-based variable optical attenuator includes a multimode interference optical waveguide having an incoming end and an outgoing end, and a thin-film heater arranged at a predetermined position on one side of left and right sides of an optical axis of the multimode interference optical waveguide. The thin-film heater is arranged at a predetermined position including at least a part of fields, among field groups appearing on the multimode interference optical waveguide, on one side of left and right sides of the optical axis.

### CROSS-REFERENCE TO RELATED APPLICATION

This application is based upon and claims the benefit of priority from the prior Japanese Patent Application No. 2005-070063, filed on Mar. 11, 2005; the entire contents of which are incorporated herein by reference.

### BACKGROUND OF THE INVENTION

1. Field of the Invention

The present invention relates to a planar waveguide-based variable optical attenuator applied to adjustment of optical signal intensity and adjustment of optical attenuation, in an optical communication system and an optical signal processing system. More specifically, the present invention relates to the planar waveguide-based variable optical attenuator applied to adjustment of intensity of amplified and branched respective signal lights of a wavelength multiplexing optical signal, in a wavelength multiplexing communication system using wavelength division multiplexing (WDM).

2. Description of the Related Art

In general, in the optical communication system, a variable optical attenuator (VOA) that adjusts the intensity of signal light to an appropriate value is essential.

Particularly, in the wavelength multiplexing communication system such as a dense wavelength division multiplexing (DWDM) and a coarse wavelength division multiplexing (CWDM), and a parallel multichannel optical communication system, it is recently required to adjust the intensity of signal light in a plurality of channels simultaneously.

Accordingly, a compact and easily integrated variable optical attenuator or variable optical attenuator array that can correspond to the parallel multichannel optical communication system is desired.

The planar waveguide-based variable optical attenuator can form an optical waveguide of an optional pattern by using a photolithographic technique, as compared to a mechanical drive variable optical attenuator, with advantages of flexible configuration and easy integration. Hence, planar waveguide-based variable optical attenuators using a thermo-optic effect or an electro-optic effect have been proposed.

Particularly, since the planar waveguide-based variable optical attenuator in the form of Mach Zehnder (MZ) has an advantage of low power consumption, the one using the thermo-optic effect and the one using the electro-optic effect have been widely studied. An example of a conventional type using the thermo-optic effect is shown in FIGS. 1 and 2.

As shown in FIGS. 1 and 2, the Mach Zehnder structure includes a Y-branch waveguide for branching input light into two, a pair of parallel waveguide arms that propagates each branched light, and a Y-coupling waveguide for coupling respective propagated lights.

By bringing the thermo-optic effect onto one of the waveguide arms, a thin-film heater for controlling the phase of light propagating on this waveguide arm is formed. Accordingly, by changing the energizing power to the thin-film heater, a phase difference between lights propagating the two waveguide arms changes, thereby enabling control of output light intensity by phase interference. Such a planner waveguide-based variable optical attenuator is disclosed in Japanese Patent Application Laid-Open Nos. 2003-29219, 2003-5139, and 2000-221345.

In the planar waveguide-based variable optical attenuator in the form of Mach Zehnder, however, the Y-branch waveguide, the Y-coupling waveguide, and the pair of parallel waveguide arms are essential in view of the structure thereof.

To ensure uniformity at the Y-branch in the Y-branch waveguide and the Y-coupling waveguide and reduce an insertion loss, it is required to make the Y-branch have a branch structure with a high symmetric property, and make a branch angle itself as small as possible.

To maintain the mutual symmetric property of the parallel waveguide arms, ideally, the both waveguide arms should have the same structure. Accordingly, it is required that an allowable production error of the both waveguide arms is suppressed as small as possible.

To respond to such a request, at least an expensive photolithographic processor that performs a highly detailed photolithographic process is necessary, thereby increasing the production cost of the planar waveguide-based variable optical attenuator.

Furthermore, even by using the highly detailed photolithographic process, it is difficult to give a capacity sufficiently satisfying the above requirement to the planar waveguide-based variable optical attenuator, thereby causing a problem in production reproducibility, and poor reproduction yield with respect to the required capacity.

If the branch angle itself of the Y-branch is made as small as possible, the length of the planar waveguide-based variable optical attenuator essentially becomes long in the portions of the Y-branch waveguide and the Y-coupling waveguide. Accordingly, it contradicts with the requirement of small size of the planar waveguide-based variable optical attenuator.

Further, for example, when a large attenuation is desired, it is necessary to connect a plurality of Mach Zehnder structures serially in multi stages, thereby further increasing the size of the planar waveguide-based variable optical attenuator.

### SUMMARY OF THE INVENTION

The present invention has been achieved in order to solve the above problems. It is one object of the present invention to provide a planar waveguide-based variable optical attenuator with excellent mass-productiveness and suitable for miniaturization at a low cost.

To achieve the above object, according to one aspect of the present invention, there is provided a planar waveguide-based variable optical attenuator comprising: a multimode interference optical waveguide having an incoming end and an outgoing end; and a thin-film heater arranged at a predetermined position on one side of left and right sides of an optical axis of the multimode interference optical waveguide.

According to another aspect of the present invention, there is provided the planar waveguide-based variable optical attenuator, wherein the thin-film heater is arranged at a predetermined position including at least a part of fields, among field groups appearing on the multimode interference optical waveguide, on one side of left and right sides of the optical axis.

According to a still another aspect of the present invention, there is provided a planar waveguide-based variable optical attenuator, comprising: a multimode interference optical waveguide; an input light waveguide and an output light waveguide continuous to a central optical axis of the multimode interference optical waveguide; and a thin-film heater arranged at a predetermined position including at least a part of fields, among field groups appearing on the multimode interference optical waveguide, on one side of left and right sides of the central optical axis.

According to a still another aspect of the present invention, there is provided the planar waveguide-based variable optical attenuator, wherein the input light waveguide and the output light waveguide are directly connected to an incoming end and an outgoing end of the multimode interference optical waveguide, respectively.

According to a still another aspect of the present invention, there is provided the planar waveguide-based variable optical attenuator, wherein the input light waveguide and the output light waveguide are respectively connected to the multimode interference optical waveguide via an input tapered waveguide and an output tapered waveguide, with the respective widths enlarging toward the multimode interference optical waveguide.

According to a still another aspect of the present invention, there is provided the planar waveguide-based variable optical attenuator, wherein the width of the thin-film heater is formed in substantially the same width as those of the input light waveguide and the output light waveguide.

According to a still another aspect of the present invention, there is provided the planar waveguide-based variable optical attenuator, wherein a core and a cladding constituting the optical waveguide are made of any one kind or a combination of two or more kinds selected from epoxy resin, acrylic resin, silicon resin, fluorinated polyimide resin, polysilane, polysiloxane resin, and silica glass.

According to a still another aspect of the present invention, there is provided the planar waveguide-based variable optical attenuator, wherein the thin-film heater is a heating thin-film heater formed by using a conductive thin-film material made of any one kind or a combination of two or more kinds selected from chromium (Cr), nickel (Ni), gold (Au), titanium (Ti), aluminum (Al), copper (Cu), tantalum (Ta), tantalum nitride (TaN), and platinum (Pt).

According to a still another aspect of the present invention, there is provided the planar waveguide-based variable optical attenuator, wherein the thin-film heater is film-formed according to sputtering, vapor deposition, or plating by using the conductive thin-film material, and formed according to photolithographic processing.

According to a still another aspect of the present invention, there is provided a planar waveguide-based variable optical attenuator array comprising a plurality of planar waveguide-based variable optical attenuators arranged in parallel on a substrate, wherein the planar waveguide-based variable optical attenuators respectively comprises: a multimode interference optical waveguide; an input light waveguide and an output light waveguide continuous to a central optical axis of the multimode interference optical waveguide; and a thin-film heater arranged at a predetermined position including at least a part of fields on one side of left and right sides of the central optical axis, among field groups appearing on the multimode interference optical waveguide.

### BRIEF DESCRIPTION OF THE ACCOMPANYING DRAWINGS

These and other objects and the configuration of this invention will become clearer from the following description of the preferred embodiments, read in connection with the accompanying drawings in which:

FIG. 1 is a schematic plan view of one example of a conventional planar waveguide-based variable optical attenuator;

FIG. 2 is a schematic plan view of another example of the conventional planar waveguide-based variable optical attenuator;

FIG. 3 is a schematic plan view of a first embodiment of a planar waveguide-based variable optical attenuator according to the present invention;

FIG. 4 is a cross section of a multimode interference (MMI) optical waveguide taken along line IV-IV in FIG. 3;

FIG. 5 is a cross section of an input light waveguide and an output light waveguide taken along line V-V in FIG. 3;

FIG. 6 is a schematic plan view of one example of a field pattern of the multimode interference (MMI) optical waveguide;

FIG. 7A is a schematic plan view of one example of an arrangement position of a thin-film heater;

FIG. 7B is a schematic plan view of another example of the arrangement position of a thin-film heater;

FIG. 8 is a graph of variation characteristic of output light attenuation due to heating temperature by the thin-film heater;

FIG. 9 is a graph of wavelength characteristic of the planar waveguide-based variable optical attenuator according to the present invention;

FIG. 10A is a schematic plan view of a second embodiment of the planar waveguide-based variable optical attenuator according to the present invention;

FIG. 10B is a schematic plan view of one example of an arrangement position of the thin-film heater;

FIG. 11A is a schematic plan view of a third embodiment of the planar waveguide-based variable optical attenuator according to the present invention;

FIG. 11B is a schematic plan view of one example of an arrangement position of the thin-film heater;

FIG. 12 is a schematic plan view of a fourth embodiment of the planar waveguide-based variable optical attenuator according to the present invention; and

FIG. 13 is a cross section of an input tapered waveguide and an output tapered waveguide taken along line XIII-XIII in FIG. 12.

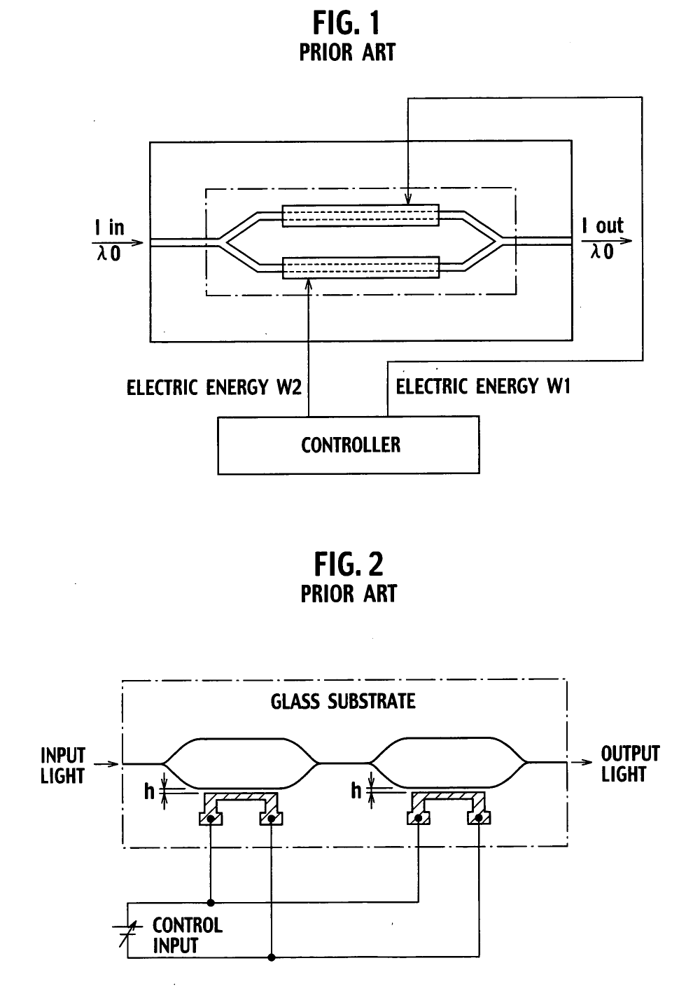

### DETAILED DESCRIPTION OF THE INVENTION

Embodiments of the present invention will be described with reference to the drawings.

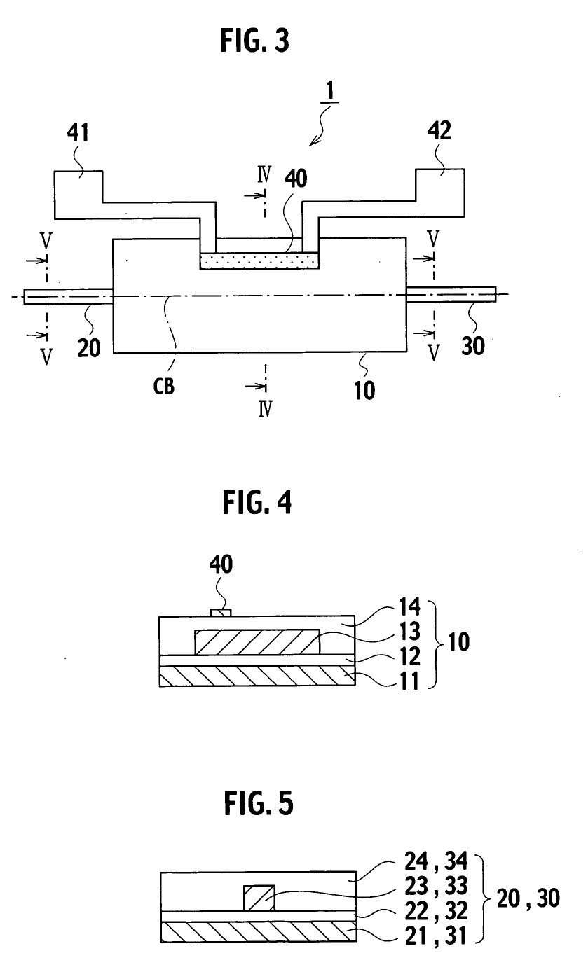

FIG. 3 shows a first embodiment of the planar waveguide-based variable optical attenuator according to the present invention. The planar waveguide-based variable optical attenuator 1 uses the thermo-optic effect of a multimode interference (MMI) optical waveguide. Therefore, the planar waveguide-based variable optical attenuator 1 includes a thin-film heater 40 at a predetermined position including a part of fields on one side of left and right sides of a multimode interference optical waveguide (hereinafter, referred to as “MMI optical waveguide”) 10.

Generally, the MMI optical waveguide has a self-focusing effect, by which a field at an incoming end is reproduced. The operation principle is to employ the characterization of the self-imaging effect and the overlapping imaging effects. Accordingly, one or a plurality of focusing fields can be obtained at a specific distance determined based on the width of the MMI optical waveguide.

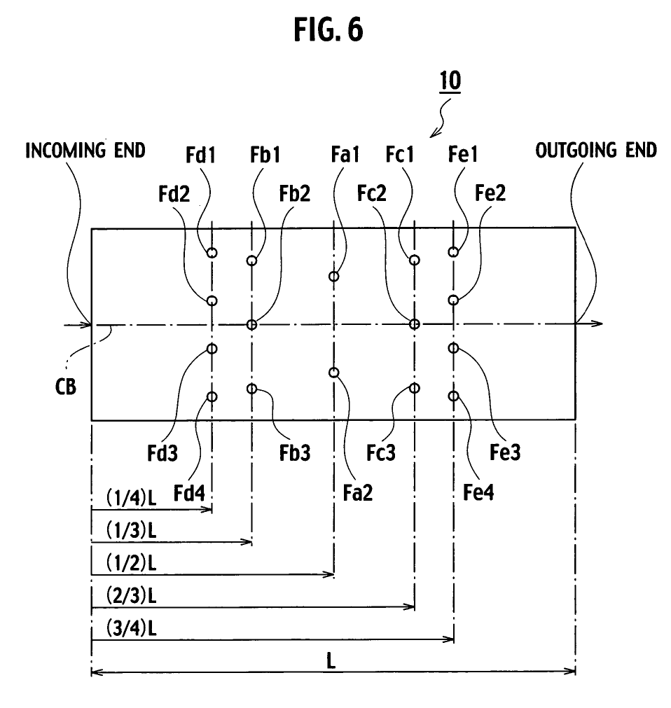

In other words, as shown in FIG. 6, in the MMI optical waveguide 10, focusing fields Fappear, dispersing in the width direction, for each predetermined distance in a lengthwise direction from an incoming end to an outgoing end.

In the case of the MMI optical waveguide 10 shown in FIG. 6, two left and right fields Fa1 and Fa2 appear, for example, at a position of ½ distance (½)L of a distance L from the incoming end to the outgoing end.

At a position of distance (⅓)L from the incoming end, three left and right fields Fb1, Fb2, and Fb3 appear.

On the other hand, at a position of distance (⅔)L from the incoming end, three left and right fields Fc1, Fc2, and Fc3 appear.

At a position of distance (¼)L from the incoming end, four left and right fields Fd1, Fd2, Fd3, and Fd4 appear.

On the other hand, at a position of distance (¾)L from the incoming end, four left and right fields Fe1, Fe2, Fe3, and Fe4 appear.

In the same way, a plurality of fields F dispersed in the left and right (width) direction appears, corresponding to a predetermined distance from the incoming end. These field groups can be easily displayed on a screen by using appropriate optical waveguide analysis software.

The MMI optical waveguide 10 can be obtained, as shown in FIG. 4, by sequentially forming a lower cladding layer 12, a core portion 13, and an upper cladding layer 14 on a silicon (Si) substrate 11.

In other words, a photopolymer material for cladding is applied on the silicon substrate 11, for example, by spin coating, developed, and baked, thereby forming the lower cladding layer 12.

A photopolymer material for the core having a larger refractive index than that of the photopolymer material for cladding is then applied on the lower cladding layer 12, for example, by spin coating, exposed by using a photomask having a core pattern formed thereon, developed and baked, thereby forming the core portion 13.

Subsequently, the photopolymer material for cladding is applied on the lower cladding layer 12 and the core portion 13, for example, by spin coating, developed, and baked, thereby forming the upper cladding layer 14.

For the photopolymer material for the core and the photopolymer material for cladding constituting the MMI optical waveguide 10, any one kind or a combination of two or more kinds selected from epoxy resin, acrylic resin, silicon resin, fluorinated polyimide resin, polysilane, and polysiloxane resin can be used.

At the front and the back of the MMI optical waveguide 10 are connected an input light waveguide 20 and an output light waveguide 30 continuous to a central optical axis CB of the MMI optical waveguide 10, having a narrower width than that of the MMI optical waveguide.

As shown in FIG. 5, the input light waveguide 20 and the output light waveguide 30 are formed in the same manner as the MMI optical waveguide 10, except that the width of the core portion is different.

In other words, the photopolymer material for cladding is applied on the silicon substrates 21 and 31, for example, by spin coating, developed, and baked, thereby forming the lower cladding layers 22 and 32.

The photopolymer material for the core having a larger refractive index than that of the photopolymer material for cladding is then applied on the lower cladding layers 22 and 32, for example, by spin coating, exposed by using the photomask having the core pattern formed thereon, developed and baked, thereby forming the core portions 23 and 33.

Subsequently, the photopolymer material for cladding is applied on the lower cladding layers 22 and 32 and the core portions 23 and 33, for example, by spin coating, developed, and baked, thereby forming the upper cladding layers 24 and 34.

For the photopolymer material for the core and the photopolymer material for cladding constituting the input light waveguide 20 and the output light waveguide 30, any one kind or a combination of two or more kinds selected from epoxy resin, acrylic resin, silicon resin, fluorinated polyimide resin, polysilane, and polysiloxane resin can be used, as in the MMI optical waveguide 10.

In the planar waveguide-based variable optical attenuator 1, the thin-film heater 40 is film-formed, for example, by sputtering and formed by patterning at a predetermined position including a part of fields, among field groups positioned on one side of left and right sides of the MMI optical waveguide 10 (in FIG. 3, the upper side or the lower side).

Specifically, the thin-film heater 40 is formed at a predetermined position including a part of fields selected from field groups positioned on either one side toward the left and right sides (In FIG. 3, either toward the upper side or toward the lower side) of the central optical axis CB of the MMI optical waveguide 10, but not including fields located on the central optical axis CB of the MMI optical waveguide 10 (for example, Fb2 and Fc2 in FIG. 6).

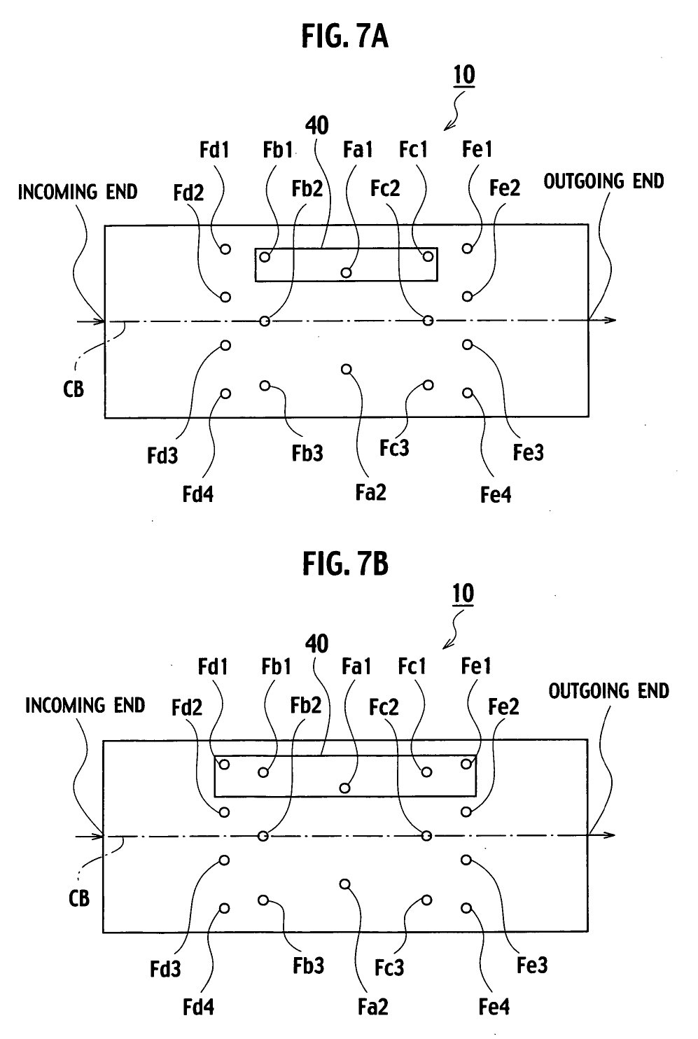

In other words, for example, when the field pattern of the MMI optical waveguide 10 is as shown in FIG. 6, as one example, the position for forming the thin-film heater 40 can be set in an area covering the fields Fa1, Fb1, and Fc1 located on the left side (the upper side in FIG. 3 and FIG. 7A) of the MMI optical waveguide 10, as shown in FIG. 7A.

In this case, the thin-film heater 40 can be set in an area covering the fields Fa2, Fb3, and Fc3 located on the right side (the lower side in FIG. 3 and FIG. 7A) of the MMI optical waveguide 10, likewise.

As another example, as shown in FIG. 7B, the thin-film heater 40 can be set in an area covering the fields Fa1, Fb1, and Fc1 located on the left side (the upper side in FIG. 3 and FIG. 7B) of the MMI optical waveguide 10, as well as the fields Fd1 and Fe1 at the front and the back thereof.

In this case, the thin-film heater 40 can be set in an area covering the fields Fa2, Fb3, and Fc3 located on the right side (the lower side in FIG. 3 and FIG. 7B) of the MMI optical waveguide 10, as well as the fields Fd4 and Fe4 at the front and the back thereof, likewise.

The thin-film heater 40 is formed as a heating thin-film heater film-formed according to sputtering, vapor deposition, or plating by using a conductive thin-film material made of any one kind or a combination of two or more kinds selected from chromium (Cr), nickel (Ni), gold (Au), titanium (Ti), aluminum (Al), copper (Cu), tantalum (Ta), tantalum nitride (TaN), and platinum (Pt), and pattern-formed according to photolithographic processing.

The width of the thin-film heater 40 is formed in substantially the same width as those of the input light waveguide 20 and the output light waveguide 30. Further, electrodes 41 and 42 are formed at front and back opposite ends of the thin-film heater 40.

In the above planar waveguide-based variable optical attenuator 1, when electric current is made to flow to between the opposite electrodes 41 and 42 of the thin-film heater 40, the thin-film heater 40 generates heat, and heat generation by the thin-film heater 40 is transmitted to the corresponding portion of the MMI optical waveguide 10.

In other words, for example, as shown in FIG. 7A, when the thin-film heater 40 is formed in the area covering the fields Fa1, Fb1, and Fc1 located on the left side (the upper side in FIG. 3 and FIG. 7A) of the MMI optical waveguide 10, the refractive index in this area (corresponding to one of the waveguide interference arms) and the vicinity thereof changes by heating of the thin-film heater 40 with respect to the refractive index in the area including the fields Fa2, Fb3, and Fc3 located on the opposite side (corresponding to the other of the waveguide interference arms).

Due to the change in the refractive index, an optical path length of light propagating in the area including the fields Fa1, Fb1, and Fc1 (one of the waveguide interference arms) changes with respect to that of light propagating in the area including the fields Fa2, Fb3, and Fc3 (the other of the waveguide interference arms).

Due to the change in the optical path length, a phase of light propagating in the area including the fields Fa1, Fb1, and Fc1 (one of the waveguide interference arms) changes with respect to that of light propagating in the area including the fields Fa2, Fb3, and Fc3 (the other of the waveguide interference arms).

Due to the change in the phase, light propagating through the area including the fields Fa1, Fb1, and Fc1 (one of the waveguide interference arms), and light propagating through the area including the fields Fa2, Fb3, and Fc3 (the other of the waveguide interference arms) cause a phase interference on the output waveguide 30 side, thereby attenuating the propagating light at the output waveguide 30.

Accordingly, variation of the refractive index, variation of the optical path length, and variation of the phase can be controlled by changing the energizing power to the thin-film heater 40, and as a result, the attenuation of the propagating light in the output waveguide 30 can be controlled.

The planar waveguide-based variable optical attenuator 1 described above was manufactured experimentally in the following manner.

That is, the lower cladding layer 12, the core portion 13, and the upper cladding layer 14 were formed by performing spin coating, baking, and patterning by using a photosensitive polysiloxane resin as a waveguide material on the silicon (Si) substrate 11, thereby forming the MMI optical waveguide 10. At this time, the input light waveguide 20 and the output light waveguide 30 were produced collectively.

The thin-film heater 40 was formed at a predetermined position of the obtained MMI optical waveguide 10, by performing thin film sputtering and patterning.

A thermo-optic (TO) coefficient of the photosensitive polysiloxane resin was −1.3×10⁻⁴/° C. Further, a refractive index nc of a waveguide core (the core portion 13) was set to 1.446, and a refractive index difference An between the core (core portion 13) and the cladding (the lower cladding layer 12 and the upper cladding layer 14) was set to 0.004.

The width W of the MMI optical waveguide 10 was 56 micrometers, and the length L of the MMI optical waveguide 10 was 3.6 millimeters. A section size of the core portions 23 and 33 in the input light waveguide 20 and the output light waveguide 30 was set to 7×7 micrometers.

The thin-film heater 40 was formed at a position away from the central optical axis CB of the MMI optical waveguide 10 by 19 micrometers, and the width of the thin-film heater 40 was set to 7 micrometers, and the length thereof was set to 800 micrometers.

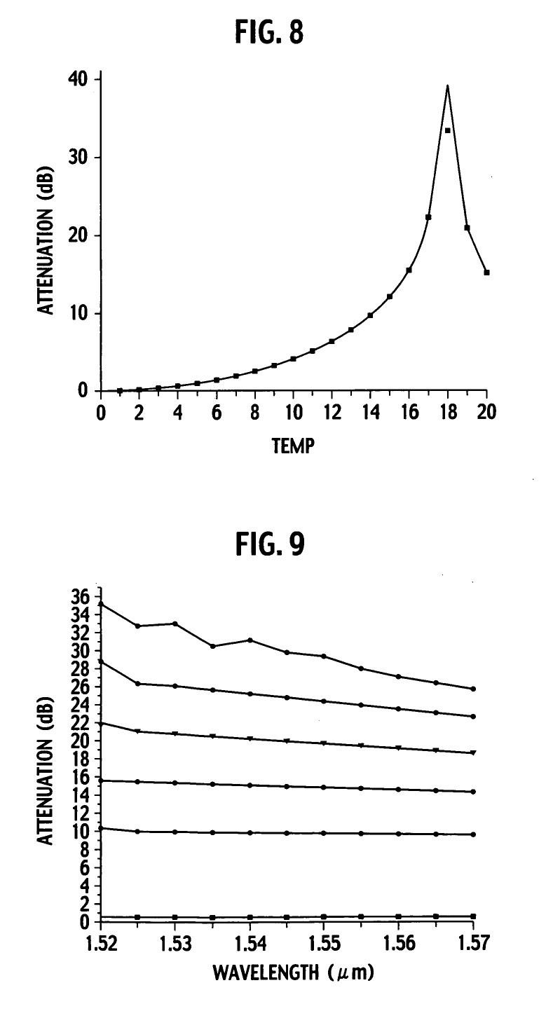

When simulation analysis was performed using the planar waveguide-based variable optical attenuator 1, as shown in FIG. 8, a maximum attenuation 39 dB could be obtained when a heating temperature difference (a difference between the heating temperature and the ambient temperature) was 18° C. by the thin-film heater 40.

A calculated value of power consumption by the thin-film heater 40 at this time was 2.7 mW, an insertion loss was 0.31 dB, and a polarization dependent loss (PDL) was very small. As shown in FIG. 9, the wavelength characteristic with respect to respective optical attenuations was excellent.

Furthermore, a planar waveguide-based variable optical attenuator array formed by arranging a plurality of planar waveguide-based variable optical attenuators 1 in parallel with a channel interval of 250 micrometers had a less cross talk between channels, that is, −70 dB or less could be realized.

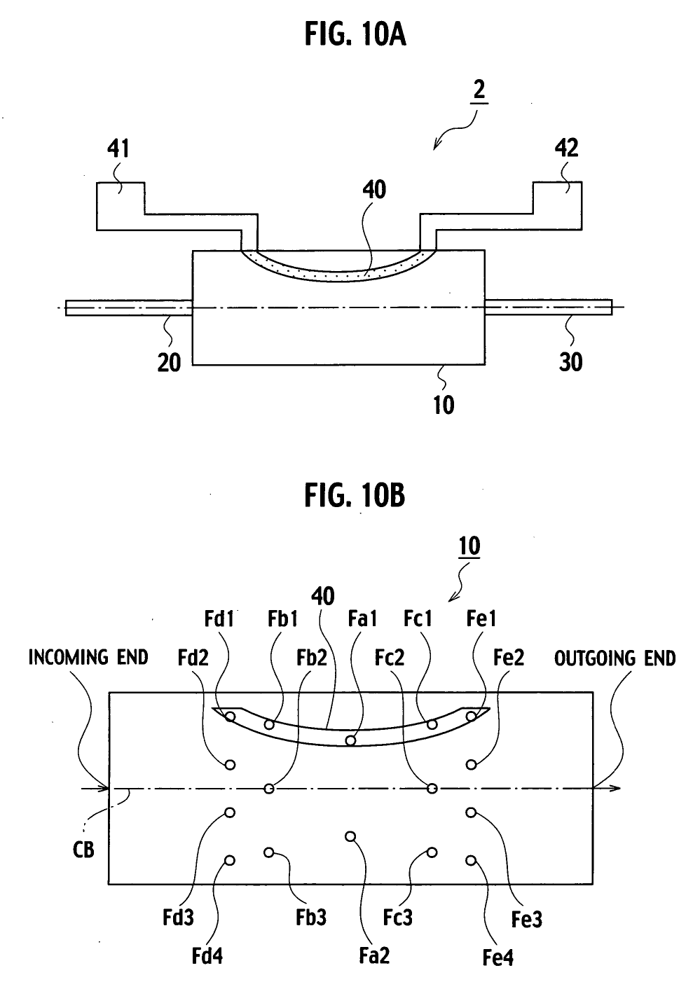

FIG. 10A shows a second embodiment of the planar waveguide-based variable optical attenuator according to the present invention. A planar waveguide-based variable optical attenuator 2 in the second embodiment is different from the planar waveguide-based variable optical attenuator 1 shown in FIG. 3 in a planar shape of the thin-film heater 40.

In other words, in the case of the planar waveguide-based variable optical attenuator 1 shown in FIG. 3, the planar shape of the thin-film heater 40 is formed in a rectangular shape.

On the other hand, the planar shape of the thin-film heater 40 in the planar waveguide-based variable optical attenuator 2 is formed in an arc shape or a curved shape as shown in FIG. 10A.

Specifically, as shown in FIG. 10B, the thin-film heater 40 is formed in an area covering the fields Fa1, Fb1, Fc1, Fd1, and Fe1 located on the left side of the MMI optical waveguide 10 (the upper side in FIGS. 10A and 10B), in a circular-arc form or a curved form.

In this case, the thin-film heater 40 can be formed in an area covering the fields Fa2, Fb3, Fc3, Fd4, and Fe4 located on the right side of the MMI optical waveguide 10 (the lower side in FIGS. 10A and 10B), in the arc shape or the curved shape, likewise.

The planar waveguide-based variable optical attenuator 2 shows substantially the same variation characteristic of the output light attenuation due to the heating temperature as in the planar waveguide-based variable optical attenuator 1 shown in FIG. 3.

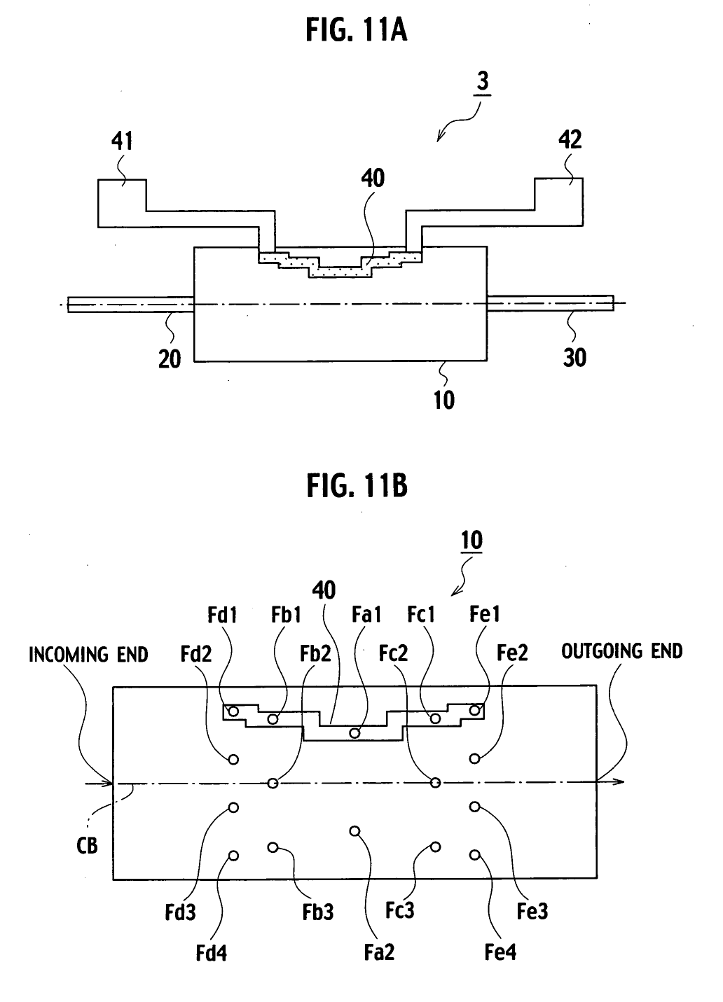

FIG. 11A shows a third embodiment of the planar waveguide-based variable optical attenuator according to the present invention. A planar waveguide-based variable optical attenuator 3 in the third embodiment is different from the planar waveguide-based variable optical attenuator 1 shown in FIG. 3 and the planar waveguide-based variable optical attenuator 2 shown in FIG. 10A in a planar shape of the thin-film heater 40. As shown in FIG. 11A, the planar shape of the thin-film heater 40 is formed stepwise.

Specifically, as shown in FIG. 11B, the thin-film heater 40 is formed in an area covering stepwise the fields Fa1, Fb1, Fc1, Fd1, and Fe1 located on the left side of the MMI optical waveguide 10 (the upper side in FIGS. 11A and 11B).

In this case, the thin-film heater 40 can be formed in an area covering stepwise the fields Fa2, Fb3, Fc3, Fd4, and Fe4 located on the right side of the MMI optical waveguide 10 (the lower side in FIGS. 11A and 11B), likewise.

The planar waveguide-based variable optical attenuator 3 shows substantially the same variation characteristic of the output light attenuation due to the heating temperature as in the planar waveguide-based variable optical attenuator 1 shown in FIG. 3 and the planar waveguide-based variable optical attenuator 2 shown in FIG. 10A.

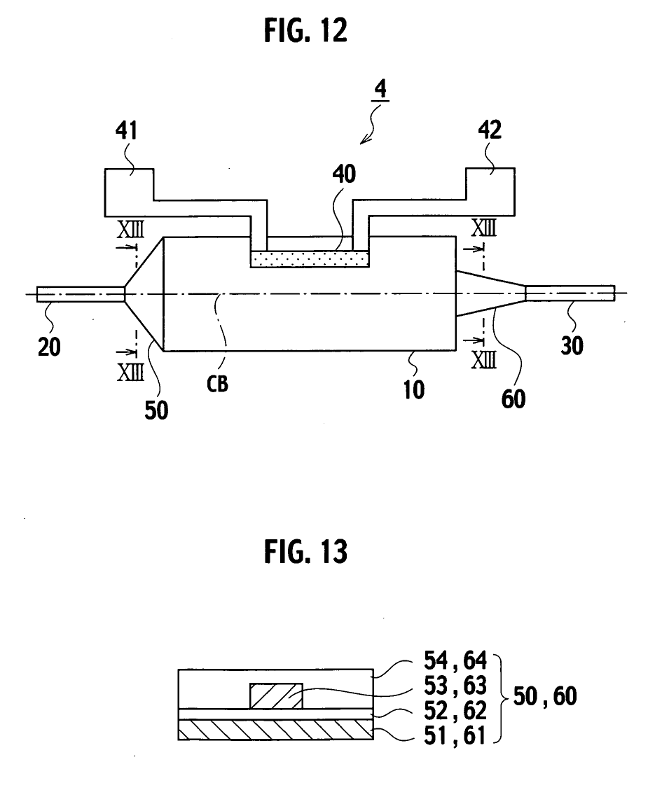

FIG. 12 shows a fourth embodiment of the planar waveguide-based variable optical attenuator according to the present invention. In a planar waveguide-based variable optical attenuator 4 in the fourth embodiment, the input light waveguide 20 is not directly connected to the MMI optical waveguide 10, but is connected to the MMI optical waveguide 10 via an input tapered waveguide 50, whose width enlarges toward the MMI optical waveguide 10.

Further, the output light waveguide 30 is not directly connected to the MMI optical waveguide 10, but is connected to the MMI optical waveguide 10 via an output tapered waveguide 60, whose width enlarges toward the MMI optical waveguide 10.

As shown in FIG. 13, the input tapered waveguide 50 and the output tapered waveguide 60 are formed in the same manner as the MMI optical waveguide 10, the input light waveguide 20 and the output light waveguide 30, except that the width of the core portion continuously changes.

In other words, a photopolymer material for cladding is applied on silicon substrates 51 and 61, for example, by spin coating, developed, and baked, thereby forming the lower cladding layers 52 and 62.

A photopolymer material for the core having a larger refractive index than that of the photopolymer material for cladding is then applied on the lower cladding layers 52 and 62, for example, by spin coating, exposed by using a photomask having a core pattern formed thereon, developed and baked, thereby forming the core portions 53 and 63.

Subsequently, the photopolymer material for cladding is applied on the lower cladding layers 52 and 62 and the core portions 53 and 63, for example, by spin coating, developed, and baked, thereby forming the upper cladding layers 54 and 64.

For the photopolymer material for the core and the photopolymer material for cladding constituting the input tapered waveguide 50 and the output tapered waveguide 60, any one kind or a combination of two or more kinds selected from epoxy resin, acrylic resin, silicon resin, fluorinated polyimide resin, polysilane, and polysiloxane resin can be used, as for the MMI optical waveguide 10, the input light waveguide 20, and the output light waveguide 30.

Otherwise, the planar waveguide-based variable optical attenuator 4 is the same as the planar waveguide-based variable optical attenuator 1 shown in FIG. 3. Therefore, like reference signs are used to refer to like parts, and duplicate explanation will be omitted.

In general, when the width W of the MMI optical waveguide 10 changes, a specific distance of fields corresponding thereto changes as well, thereby causing an excess loss of the emitted light.

Therefore, in the planar waveguide-based variable optical attenuator 4, the input light waveguide 20 and the output light waveguide 30 are connected to the MMI optical waveguide 10, respectively, via the input tapered waveguide 50 and the output tapered waveguide 60, with the respective widths enlarging toward the MMI optical waveguide 10.

As a result, according to the planar waveguide-based variable optical attenuator 4, a radiation angle at the incoming end of the MMI optical waveguide 10 can be reduced, a tolerance with respect to a position change of an outgoing field accompanying a width change in the MMI optical waveguide 10 can be improved, an insertion loss of the MMI optical waveguide 10 can be reduced, and a production yield of the waveguide can be improved.

Further, in the planar waveguide-based variable optical attenuator 4, the planar shape of the thin-film heater 40 can be formed in the circular-arc shape or the curved shape, as shown in FIG. 10, or in a step-wise shape as shown in FIG. 11.

The planar waveguide-based variable optical attenuators 1 to 4 all include the MMI optical waveguide 10, the thin-film heater 40, as well as the input light waveguide 20 and the output light waveguide 30. The MMI optical waveguide 10 has a very simple structure, and hence, a loss is fundamentally very small, and a tolerance with respect to a production error is high as compared to other waveguides. As a result, it is most suitable for producing a large-scale optical integrated circuit.

In other words, according to the planar waveguide-based variable optical attenuators 1 to 4, since the Y-branch waveguide and the Y-coupling waveguide, which have a problem in the production reproducibility in the conventional MZ interference waveguide, are not necessary, the structure is quite simple and small. Further, since those planar waveguide-based variable optical attenuators 1 to 4 do not require the expensive photolithographic processor for performing the highly detailed photolithographic process, those planar waveguide-based variable optical attenuators can largely contribute to reduction of the production cost and improvement of the yield.

Further, according to the planar waveguide-based variable optical attenuators 1 to 4, the structure is quite simple and small, and since the highly detailed photolithographic process is not necessary, low cost and mass-productiveness can be realized. Since the structure is small and power consumption is low, and the crosstalk between channels is low, the planar waveguide-based variable optical attenuators 1 to 4 are most suitable for the configuration of the planar waveguide-based variable optical attenuator array of a plurality of channels.

In the above embodiments, the photopolymer resin material (e.g., UV curable polymer) is used as a material for forming the optical waveguide, but other than these polymer resins, a material capable of forming an optical waveguide such as silica glass and a semiconductor can be used.

While preferred embodiments of the present invention have been described above, the foregoing description is in all aspects illustrative. It is therefore understood that numerous modifications can be devised without departing from the spirit or scope of the appended claims of the invention.

What is claimed is:

1. A planar waveguide-based variable optical attenuator comprising:
a multimode interference optical waveguide having an incoming end and an outgoing end; and
a thin-film heater arranged at a predetermined position on one side of left and right sides of an optical axis of the multimode interference optical waveguide.

2. The planar waveguide-based variable optical attenuator according to claim 1, wherein the thin-film heater is arranged at a predetermined position including at least a part of fields, among field groups appearing on the multimode interference optical waveguide, on one side of left and right sides of the optical axis.

3. A planar waveguide-based variable optical attenuator, comprising:
a multimode interference optical waveguide;
an input light waveguide and an output light waveguide continuous to a central optical axis of the multimode interference optical waveguide; and
a thin-film heater arranged at a predetermined position including at least a part of fields, among field groups appearing on the multimode interference optical waveguide, on one side of left and right sides of the central optical axis.

4. The planar waveguide-based variable optical attenuator according to claim 3, wherein the input light waveguide and the output light waveguide are directly connected to an incoming end and an outgoing end of the multimode interference optical waveguide, respectively.

5. The planar waveguide-based variable optical attenuator according to claim 3, wherein the input light waveguide and the output light waveguide are respectively connected to the multimode interference optical waveguide via an input tapered waveguide and an output tapered waveguide, with the respective widths enlarging toward the multimode interference optical waveguide.

6. The planar waveguide-based variable optical attenuator according to claim 3, wherein the width of the thin-film heater is formed in substantially the same width as those of the input light waveguide and the output light waveguide.

7. The planar waveguide-based variable optical attenuator according to claim 3, wherein a core and a cladding constituting the optical waveguide are made of any one kind or a combination of two or more kinds selected from epoxy resin, acrylic resin, silicon resin, fluorinated polyimide resin, polysilane, polysiloxane resin, and silica glass.

8. The planar waveguide-based variable optical attenuator according to claim 3, wherein the thin-film heater is a heating thin-film heater formed by using a conductive thin-film material made of any one kind or a combination of two or more kinds selected from chromium (Cr), nickel (Ni), gold (Au), titanium (Ti), aluminum (Al), copper (Cu), tantalum (Ta), tantalum nitride (TaN), and platinum (Pt).

9. The planar waveguide-based variable optical attenuator according to claim 8, wherein the thin-film heater is film-formed according to sputtering, vapor deposition, or plating by using the conductive thin-film material, and formed according to photolithographic processing.

10. A planar waveguide-based variable optical attenuator array comprising a plurality of planar waveguide-based variable optical attenuators according to claim 3 arranged in parallel on a substrate.
